(19) United States
(12) Patent Application Publication
(10) Pub. No.: US 2016/0018810 A1
(43) Pub. Date: Jan. 21, 2016

(54) LASER PROCESSSING SYSTEM FOR PROCESSING WORKPIECE WITH LASER

(71) Applicant: FANUC CORPORATION, Yamanashi (JP)

(72) Inventors: Atsushi Mori, Yamanashi (JP); Yuji Nishikawa, Yamanashi (JP)

(73) Assignee: FANUC CORPORATION, Yamanashi (JP)

(21) Appl. No.: 14/798,842

(22) Filed: Jul. 14, 2015

(30) Foreign Application Priority Data
Jul. 15, 2014 (JP) 2014-145260

(51) Int. Cl. G05B 19/18

(52) U.S. Cl. CPC G05B 19/182; G05B 2219/45165

(57) ABSTRACT

A laser processing system that processes a workpiece with a laser includes a processing interruption unit that interrupts laser processing of the workpiece in accordance with an interruption signal, a processing resumption unit that resumes the laser processing of the workpiece after the interruption signal is cancelled, and an interruption point visualizer providing unit that provides the workpiece with an interruption point visualizer that allows an interruption point on the workpiece where the laser processing is interrupted by the processing interruption unit to be visually recognized.

### BACKGROUND OF THE INVENTION

1. Field of the Invention

The present invention relates to a laser processing system that processes a workpiece with a laser.

2. Description of the Related Art

During processing of a workpiece with a laser processing machine, the processing may be interrupted because of an instruction of the operator or a specific interruption instruction. The specific interruption instruction originates from an unexpected incident such as occurrence of power failure or a drop of supply pressure of the laser gas.

Laser processing machines according to Japanese Laid-open Patent Publication No. 2003-225783, Japanese Laid-open Patent Publication No. 2004-306073, and Japanese Laid-open Patent Publication No. 2010-120071 are configured to resume the processing even when the processing is interrupted as above.

However, the processing quality obtained when the laser processing is once interrupted and then resumed from the interruption point is often inferior to the normal processing quality obtained by continuously performing the laser processing. A reason of this will be explained below, referring to a laser cutting process as an example of the laser processing.

In the laser cutting process, molten workpiece and assist gas are discharged through a kerf formed backward of the advancing direction of the cut point. In addition, it is necessary to set the cutting speed such that the energy input by the laser beam and the energy release by discharging the molten workpiece are balanced, in order to achieve high laser cutting quality.

However, when the laser cutting is once interrupted and then resumed from the interruption point, the laser processing head has to be accelerated while performing the laser cutting, and hence the cutting performance becomes unstable. Accordingly, in such a case the laser processing head is moved backward by several millimeters along the laser processing route. The laser cutting is then resumed when the laser processing head reaches the designated processing speed after starting to move forward along the processing route.

In the laser cutting process, the workpiece may be defectively cut when a laser output condition and/or a cutting speed condition are inappropriate. Accordingly, when the laser cutting is once interrupted and then resumed from the interruption point, the following drawbacks may be incurred.

First, since the laser beam is again emitted on the kerf already formed, the wall surface of the kerf may be remolten and removed, and therefore the cut surface may be roughened and the remolten workpiece may coagulate on the bottom surface thereby forming a dross (burr). Second, when the laser cutting is once interrupted, a stepped portion may be formed on the cut surface of the workpiece at the position where the processing is resumed, because of thermal contraction originating from a temperature drop of the workpiece. Third, since the processing performance is unstable, the workpiece may not be completely cut through by the laser and a part of the workpiece may be left uncut.

It is quite difficult to discover such drawbacks incidental to the laser cutting process after resuming the laser cutting. For example, the dross is formed on the rear side of the workpiece, and is hence unable to be discovered when the workpiece is viewed from the side of the front surface. In addition, the roughened state and the stepped portion of the cut surface of the workpiece are difficult to distinguish unless the workpiece that has been cut is actually picked up and closely examined.

Further, in the laser cutting process, normally a multitude of products are cut out from a single steel plate of a standard length, for example 3 m×1.5 m. Those products are not completely cut apart from each other but connected to the workpiece via a thin uncut portion (micro joint), thus to prevented from scattering. Such a technique is known as micro joint processing.

However, an uncut portion similar to the micro joint may remain, also when the laser cutting is once interrupted by a specific interruption instruction originating from an unexpected incident and then resumed. It is quite difficult to distinguish such an uncut portion from the intentionally formed micro joint portions. In addition, the position and the shape of the uncut portion formed owing to the specific interruption instruction are often irregular, and therefore the uncut portion may be subjected to an unintended force when the products are taken out from the mother material, which may result in deformation of the products.

In the uncut portion formed because of the specific interruption instruction, the kerf may not be formed throughout the workpiece even though the kerf appears to have been continuously formed when viewed from the front surface of the workpiece. In such a case also, it is difficult to discover the interrupted portion.

Further, when the workpiece having the foregoing drawbacks is delivered to the subsequent process after the laser cutting is once interrupted and the resumed, the opportunity to remove or correct the products of low quality may be lost, and the low-quality products may flow out. In addition, delivering the low-quality workpiece to the subsequent process may further degrade the quality of the product. This also applies to the laser processing in general, not only to the laser cutting.

The present invention has been accomplished in view of the foregoing situation, and provides a laser processing system that allows an operator to easily visually recognize a position where the laser processing is once interrupted.

### SUMMARY OF THE INVENTION

In a first aspect, the present invention provides a laser processing system that processes a workpiece with a laser, including a processing interruption unit that interrupts laser processing of the workpiece in accordance with an interruption signal, a processing resumption unit that resumes the laser processing of the workpiece after the interruption signal is cancelled, and an interruption point visualizer providing unit that provides the workpiece with an interruption point visualizer that allows an interruption point on the workpiece where the laser processing is interrupted by the processing interruption unit to be visually recognized.

In a second aspect, the interruption point visualizer in the laser processing system of the first aspect is an index formed by one of engraving, printing, and application of paint, on the interruption point on the workpiece.

In a third aspect, the interruption point visualizer in the laser processing system of the first aspect is an index formed by laser processing on the interruption point on the workpiece.

In a fourth aspect, the interruption point visualizer in the laser processing system of the first aspect is the interruption point to be visually recognized when a visible light emitting unit emits visible light onto the interruption point.

In a fifth aspect, the laser processing system of the first aspect further includes a storage unit that stores information of the workpiece to which the interruption point visualizer is provided and information of a position on the workpiece where the interruption point visualizer is located, in association with each other, and a display unit that displays the information of the workpiece to which the interruption point visualizer is provided, or both of the information of the workpiece to which the interruption point visualizer is provided and the information of the position on the workpiece where the interruption point visualizer is located.

In a sixth aspect, in the laser processing system of the first aspect, an index is provided on the workpiece in a form of character information, or a shape or a color of the index or of visible light emitted to the interruption point is changed depending on a cause of the interruption signal or a number of times that the interruption signal has been generated.

In a seventh aspect, the laser processing system of the second or third aspect is configured to produce at least one product from the workpiece, and the interruption point visualizer providing unit provides the product in the workpiece with the interruption point visualizer.

In an eighth aspect, the laser processing system of the second or third aspect is configured to produce at least one product from the workpiece, and the interruption point visualizer providing unit provides the interruption point visualizer to a remaining portion of the workpiece except for the product.

These and other objects, features and advantages of the present invention will become more apparent through the detailed description of typical embodiments of the present invention, given hereunder with reference to the accompanying drawings.

### BRIEF DESCRIPTION OF THE DRAWINGS

FIG. 1 is a schematic perspective view with a block diagram of a laser processing system according to a first embodiment of the present invention;

FIG. 2 is a plan view of an example of a workpiece;

FIG. 3 is a flowchart for explaining an operation of the laser processing system of FIG. 1;

FIG. 4A is a schematic perspective view of a laser processing system according to a second embodiment of the present invention;

FIG. 4B is a schematic perspective view of another laser processing system according to the second embodiment of the present invention;

FIG. 5 is a schematic perspective view of still another laser processing system according to the present invention;

FIG. 6A is a plan view of a product;

FIG. 6B is a plan view of a product in the workpiece; and

FIG. 7 is a schematic drawing of a laser processing system according to another embodiment of the present invention.

### DETAILED DESCRIPTION

Hereafter, embodiments of the present invention will be described with reference to the drawings. In all the drawings, the same constituents will be given the same reference numeral. In addition, the constituents may be illustrated in different scales, for the sake of clarity.

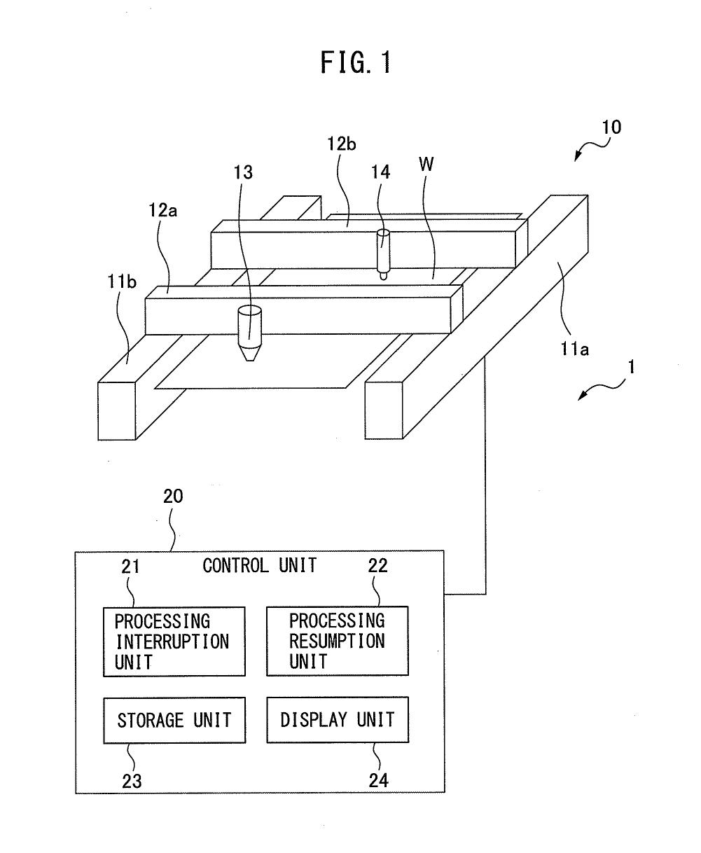

FIG. 1 is a schematic perspective view of a laser processing system according to a first embodiment of the present invention. As illustrated in FIG. 1, the laser processing system 1 essentially includes a laser processing machine 10 and a control unit 20 that controls the laser processing machine 10. The laser processing machine 10 illustrated in FIG. 1 is, for example, a laser cutting apparatus. The laser processing machine 10 includes a pair of guide rails 11a and 11b disposed parallel to each other, and a plate-shaped workpiece W is placed between the guide rails 11a and 11b.

Positioning rails 12a and 12b are provided on the guide rails 11a and 11b, perpendicular thereto. The lengths of the positioning rails 12a and 12b are generally the same as the distance between the guide rails 11a and 11b. The positioning rails 12a and 12b are set to slide in the longitudinal direction of the guide rails 11a and 11b.

As illustrated in FIG. 1, further, a laser processing head 13 that outputs a laser beam is slidably attached to one of the positioning rails (in this embodiment, 12a). The laser processing head 13 is connected to a non-illustrated laser oscillator, and controlled by the control unit 20.

The positioning rail 12a to which the laser processing head 13 is attached slides along the guide rails 11a and 11b, and the laser processing head 13 is also set to slide along the positioning rail 12a. Accordingly, the laser processing head 13 can be located at a desired position on the workpiece W, so as to cut the workpiece W in a desired shape.

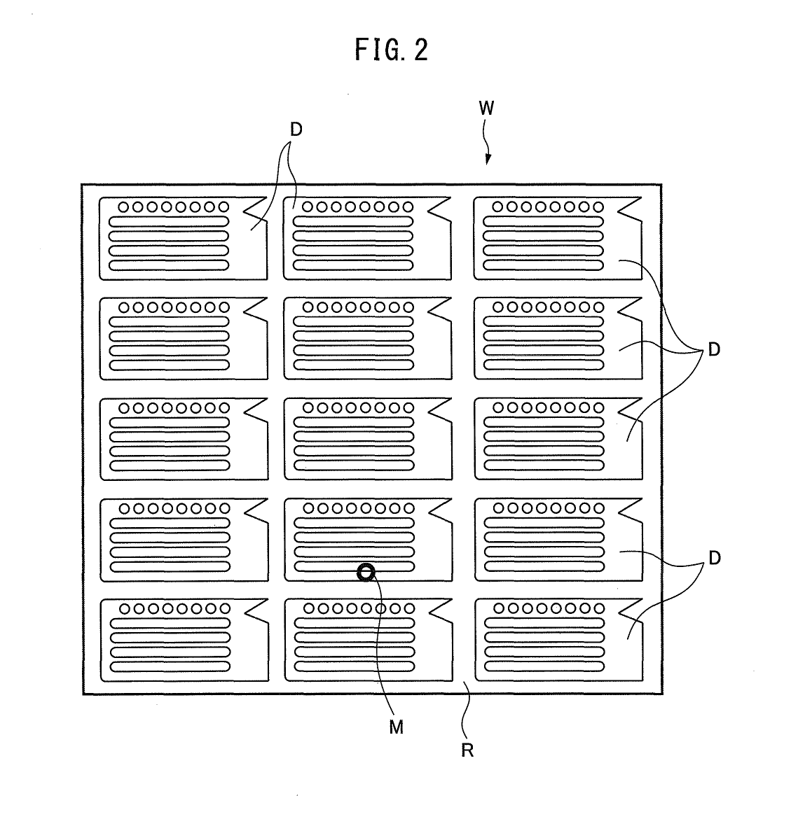

FIG. 2 illustrates an example of the workpiece. Solid lines in the workpiece W of FIG. 2 indicate processing routes along which the cutting is to be performed by the laser processing machine 10. The processing routes indicated in FIG. 2 are arranged so as to obtain products D in three rows by five columns. When the workpiece W is cut along the processing routes, a plurality of products D of the same shape are obtained. In other words, the laser processing machine 10 divides the workpiece W into the plurality of products D and a residual portion R that remains after the products are removed. In this connection, a single piece of product D may be cut out from a single piece of workpiece W.

More precisely, the laser processing machine 10 does not completely divide the workpiece W into the products D and the residual portion R illustrated in FIG. 2. Each of the products D and the residual portion R are connected to each other via at least one non-illustrated micro joint (uncut portion). The micro joint is intentionally formed when the laser processing is once interrupted according to an instruction based on the processing program, and then the laser processing is resumed by moving the laser processing head 13 by a predetermined small distance along the laser processing route. In this connection, even though the laser processing machine 10 is set to completely divide the workpiece W into the products D and the residual portion R, the present invention is equally applicable.

Referring again to FIG. 1, a marker 14, for example a paint application unit, is slidably attached to the other positioning rail 12b. The marker 14 serves as an index providing unit that provides an index M on a position on the workpiece W where the laser processing is resumed after the laser processing is interrupted by an instruction of the operator or a specific interruption instruction because of an unexpected incident. The marker 14 applies a paint to form the index M. Similar to the laser processing head 13, the marker 14 is also movable to a desired position in the laser processing machine 10.

The control unit 20 is a digital computer configured to operate the laser processing machine 10 so as to perform the laser processing of the workpiece W in accordance with an operation program prepared in advance. The control unit 20 includes a processing interruption unit 21 that interrupts the laser processing of the workpiece halfway of the processing according to an interruption signal, and a processing resumption unit 22 that resumes the laser processing of the workpiece after the interruption signal is cancelled.

The interruption signal is generated by an interruption signal generation unit (not illustrated) upon occurrence of an unexpected incident. The unexpected incident herein refers to, for example, occurrence of power failure, a drop of supply pressure of the laser gas, and detection of a processing defect by a non-illustrated sensor. The operator may generate the interruption signal if necessary.

As stated earlier, the laser output is also interrupted when the micro joint is formed during the laser processing. However, such interruption of the laser output is stipulated in the operation program of the laser processing machine 10, to be intentionally performed. Accordingly, the interruption signal herein referred to will not be generated in such a case, and hence the process to be subsequently described will not be performed either.

As illustrated in FIG. 1, further, the control unit 20 includes a storage unit 23 that stores therein information of a position where the positioning rail 12a and the laser processing head 13 are located when the laser processing is interrupted by the processing interruption unit 21, and various types of operational information of the laser processing machine 10 related to the interruption, and a display unit 24, for example an LCD.

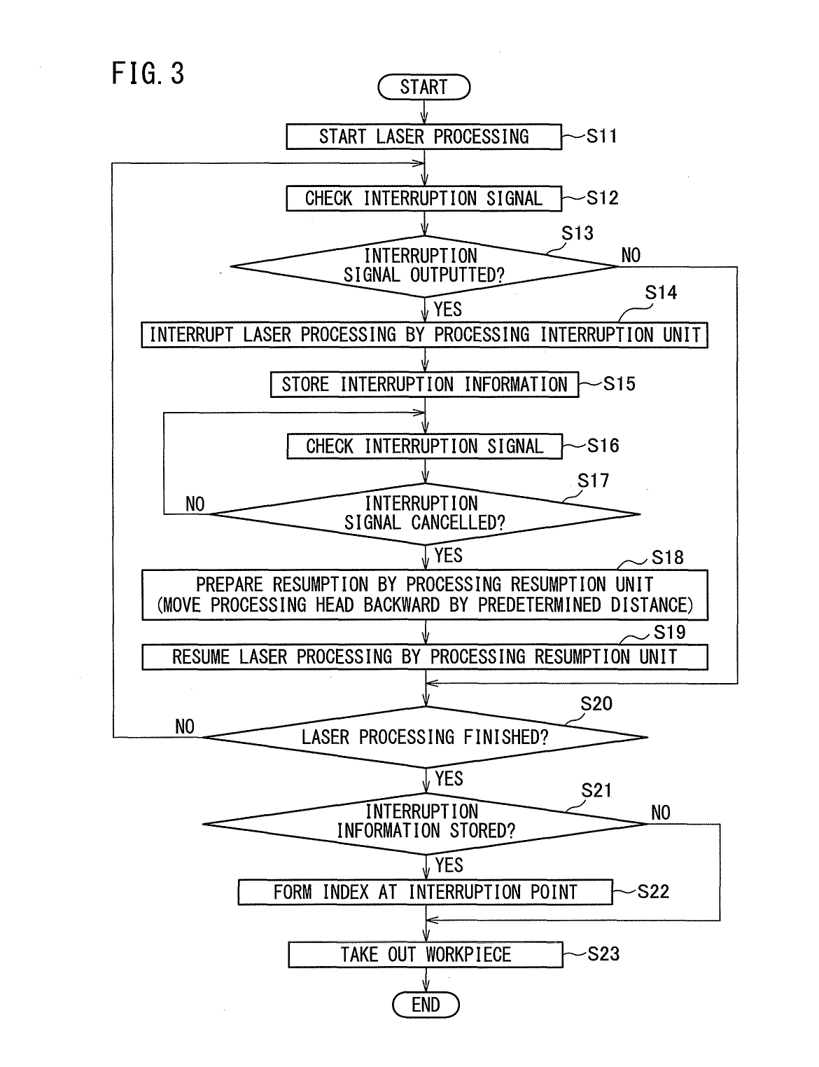

FIG. 3 is a flowchart for explaining the operation of the laser processing system of FIG. 1. Referring to FIG. 1 to FIG. 3, the operation of the laser processing system according to the present invention will be described hereunder. It is herein assumed that the following operation is performed at predetermined intervals during the control operation. It will also be assumed that the workpiece W is already placed in a predetermined position between the guide rails 11a and 11b, before step S11 of FIG. 3 is performed.

First, at step S11 the laser processing head 13 is activated to start the laser processing of the workpiece W. At step S12, the control unit 20 decides whether an interruption signal of the laser processing has been outputted. When it is decided at step S13 that the interruption signal has not been outputted, the operation returns to step S12 to continue with the laser processing, unless the laser processing is finished at step S20.

In contrast, when it is decided that the interruption signal has been outputted owing to an unexpected incident, the operation proceeds to step S14. At step S14, the processing interruption unit 21 interrupts the laser processing. More specifically, the processing interruption unit 21 stops the laser output from the laser processing head 13. The processing interruption unit 21 also stops the laser processing head 13 on the positioning rail 12a, and stops the positioning rail 12a on the guide rails 11a and 11b.

At step S15, the storage unit 23 stores the stop position of the positioning rail 12a in the longitudinal direction of the guide rails 11a and 11b, and the stop position of the laser processing head 13 in the longitudinal direction of the positioning rail 12a. In other words, the storage unit 23 stores the interruption point of the laser processing. At this time, the storage unit 23 also stores various types of operational information of the laser processing machine 10 at the time of the interruption of the laser processing.

At step S16, the control unit 20 decides whether the interruption signal has been cancelled. When it is decided at step S17 that the interruption signal has not been cancelled, the operation returns to step S16 and maintains the interruption of the laser processing.

In contrast, when it is decided that the interruption signal has been cancelled, the operation proceeds to step S18. At step S18, preparation for resuming the laser processing is performed, including moving the laser processing head 13 to a position appropriate for resuming the laser processing. For example, the laser processing head 13 may be moved backward by a predetermined distance along the laser processing route. At step S19, the processing resumption unit 22 drives the positioning rail 12a and the laser processing head 13 so as to cause the laser processing head 13 to move ahead in the advancing direction along the laser processing route. When the laser processing head 13 reaches a designated processing speed, the processing resumption unit 22 causes the laser processing head 13 to output the laser beam. The laser processing is thus resumed. In this case, the interruption point and the resumption point of the laser processing are the same.

The laser processing may be resumed through another procedure. For example, when a plurality of products D are formed from a single piece of workpiece W, the laser processing head 13 may be moved at step S18 to the position of the product D to be processed posterior to the product D being processed at the time that the interruption signal is outputted. Then the processing resumption unit 22 may cause the laser processing head 13 to output the laser beam at step S19.

At step S20, the control unit 20 decides whether the laser processing job specified in the operation program has been finished, and returns to step S12 when the laser processing job has not been finished yet. When it is decided that the laser processing job has been finished, the laser processing head 13 is retracted. The retracted position of the laser processing head 13 may be set, for example, in the vicinity of an end portion of the guide rail 11a. It is preferable that the retracted position of the laser processing head 13 is sufficiently spaced from the workpiece W so as not to interfere with the operation of the marker 14.

After the laser processing is finished, it is decided at step S21 whether the interruption information has been stored at step S15 because of interruption of the laser processing. When it is decided that the laser processing has not been interrupted during the period between the start and finish of the laser processing job, the workpiece W is taken out at step S23, and the operation is finished.

When it is decided at step S21 on the basis of the interruption information that the laser processing was interrupted, the stop position of the laser processing head 13 is retrieved from the storage unit 23 at step S22, and the positioning rail 12a and the laser processing head 13 are driven so as to move the marker 14 to the stop position. Then the marker 14 applies paint to the workpiece W thereby forming an index M at the stop position of the laser processing head 13. In FIG. 2, the index M is marked on a part of the product D in the fourth row and the second column. Then at step S23 the workpiece W is taken out of the laser processing machine 10 and the operation is finished.

As described above, in the present invention the index M is marked on the point where the laser processing is interrupted. Such an arrangement enables the operator to recognize that the workpiece W includes the interruption point simply by viewing the workpiece W, and to easily identify the position of the interruption point. Therefore, the operator can promptly evaluate the product D having the index M, and secure the opportunity to remove or amend the product D if necessary. Further, the workpiece W containing the product D having the interruption point is prevented from being delivered to the subsequent process, and therefore degradation in quality of the product can be prevented.

When the index M is marked on the interruption point, the display unit 24 may indicate to which position of the workpiece W the index M has been marked. In this case, it is preferable that the display unit 24 displays the graphic data of the workpiece W and the product D with the index M as illustrated in FIG. 2. Such an arrangement further facilitates the operator to visually recognize the interruption/resumption point.

In the embodiment described with reference to FIG. 3, the marker 14 is moved to the stop position after the laser processing is finished. However, after the laser processing is interrupted at step S14 of FIG. 3, the laser processing head 13 may be retracted, the marker 14 may also be moved to the interruption point and the index M may be provided. In this case, the laser processing head 13 is moved to the interruption point stored in the storage unit 23 after the index M is provided, to resume the laser processing.

In the foregoing description, the marker 14 applies a paint to form the index M. Employing a paint of a different color from the workpiece W increases the visibility of the index M, thereby facilitating the operator to recognize the index M. The marker 14 may be an engraving apparatus or a printing apparatus, in which case the index M is formed by engraving or printing, respectively. It is obvious that the same advantage can be attained in these cases.

Further, the laser processing head 13 may be used as a marker, instead of the marker 14. For example, the output of the laser processing head 13 may be lowered to such a level that prevents the workpiece W from being cut through, and then the index M may be formed on the workpiece W by laser marking. Alternatively, the workpiece W may be perforated by laser cutting, or a bead-on-plate may be formed on the workpiece W by laser welding, so as to utilize the hole or the bead as the index M. In such cases the marker 14 is unnecessary, and hence there is no need to additionally prepare the engraving apparatus, the printing apparatus, or the paint application unit. Therefore, the marker 14 and the positioning rail 12b can be excluded and resultantly the cost of the laser processing system 1 can be reduced.

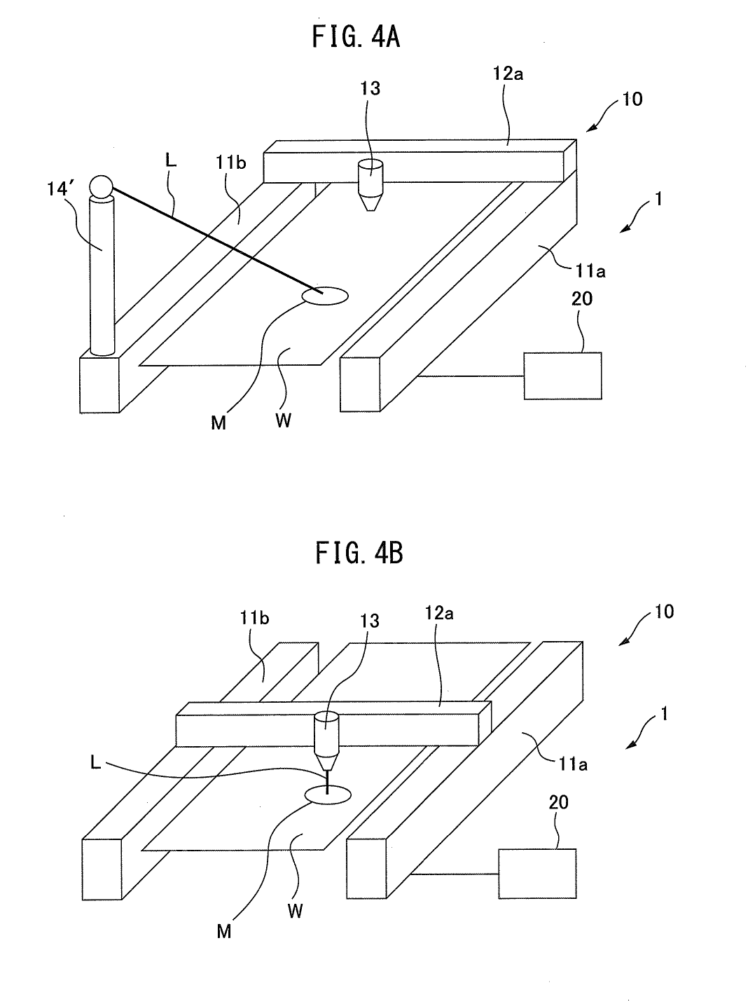

FIG. 4A is a schematic perspective view of a laser processing system according to a second embodiment of the present invention. In FIG. 4A, the positioning rail 12b and the marker 14 are excluded. A visible light emitting unit 14′, for example a laser pointer, that spot-irradiates a desired position with visible light is provided in the vicinity of an end portion of the guide rail 11b.

In the embodiment illustrated in FIG. 4A, the visible light emitting unit 14′ is activated after the laser processing head 13 is retracted at step S21 in FIG. 3, and the interruption point stored in the storage unit 23 is spot-irradiated with the visible light. In the embodiment illustrated in FIG. 4A, the spot irradiation corresponds to the index M, and therefore the visible light emitting unit 14′ serves as an index providing unit. Accordingly, it is apparent that the embodiment of FIG. 4A also provides the same advantages as those provided by the foregoing embodiment.

When a plurality of indices M have to be marked in the embodiment of FIG. 4A, one of the interruption points may be spot-irradiated for a predetermined time, for example one second, and then a next interruption point may be spot-irradiated in the same way. Such an arrangement enables the operator to visually recognize the interruption points even when the laser processing is interrupted a plurality of times.

Alternatively, after the workpiece W subjected to the laser processing is taken out of the laser processing machine 10 and placed on another location, for example a transport table, the workpiece W on the transport table may be spot-irradiated with the visible light. In this case, the stop position stored in the storage unit 23, positional relationship between the laser processing machine 10 and the transport table, and the positional relationship between the transport table and the workpiece W are required.

FIG. 4B is a schematic perspective view of another laser processing system according to the second embodiment of the present invention. In FIG. 4B, the positioning rail 12b, the marker 14, and the visible light emitting unit 14′ are excluded. Instead, the laser processing head 13 is configured to emit a probe light in addition to the laser beam.

In the embodiment illustrated in FIG. 4B, after the laser processing is finished the laser processing head 13 is not returned to the retracted position but moved to the interruption point stored in the storage unit 23. Then laser processing head 13 emits the probe light onto the workpiece W at the position corresponding to the interruption point. Normally the probe light is a low-output visible light laser coaxially superposed on the high-output laser for allowing the operator to recognize the position to which the high-output laser for processing is emitted. The emission of such a probe light corresponds to the index M, and hence the laser processing head 13 serves also as an index providing unit. Accordingly, it is apparent that the embodiment of FIG. 4B also provides the same advantages as those provided by the foregoing embodiment. In addition, the embodiment of FIG. 4B further reduces the cost of the laser processing machine 10.

In the embodiments illustrated in FIG. 4A and FIG. 4B, workpiece W is not subjected to engraving or paint application, and therefore a permanent index M is not provided on the workpiece W. Accordingly, the workpiece W and the product D are prevented from being damaged, and the engraved sign or painted mark is not left on the workpiece W and the product D. Further, it suffices that simply the visible light or the probe light is emitted, which shortens the time required for forming the index M.

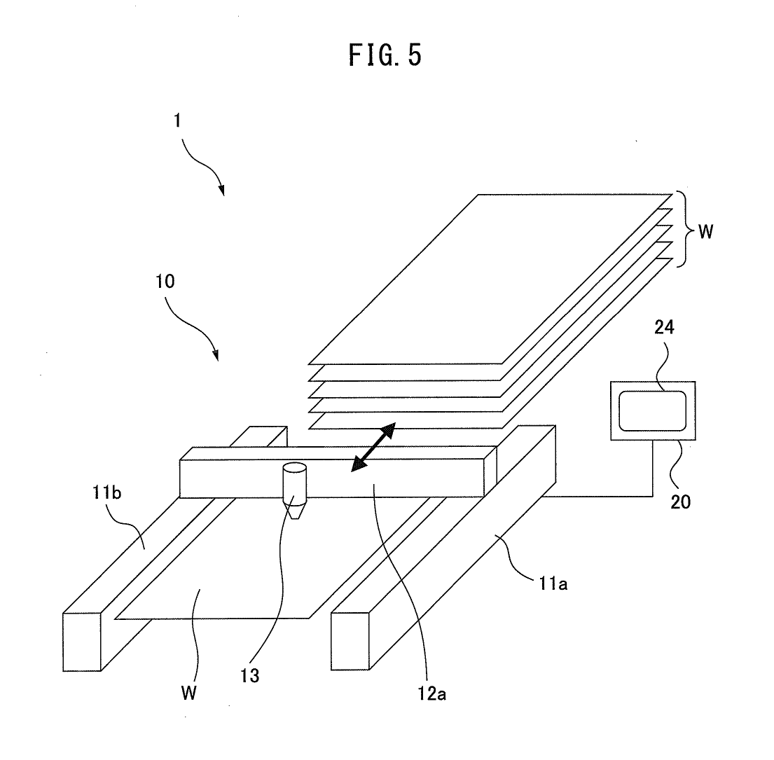

FIG. 5 is a schematic perspective view of still another laser processing system according to the present invention. In the embodiment illustrated in FIG. 5, the laser processing machine 10 is set to process a plurality of workpieces W by turns. The plurality of workpieces W are each given a number in advance. When the index M is provided on one of the plurality of workpieces W, the storage unit 23 stores the number of the workpiece W on which the index M is provided, in addition to the position of the index M on the workpiece W. In other words, the storage unit 23 stores information indicating which number of workpiece W is provided with the index M.

The information stored in the storage unit 23 is displayed on the display unit 24. Accordingly, the operator can easily recognize which of the plurality of workpieces W has the interruption point. It is preferable to display the number of the workpiece W on which the index M is provided and the position of the index M on the display unit 24 each time the index M is provided during the laser processing job. Such an arrangement is especially advantageous when a large number of workpieces W are to be processed. Further, it is possible to provide a similar index at an end portion or an edge portion of the workpiece W on which the index M is provided, so as to facilitate for the operator the workpiece M having the interruption point to be identified.

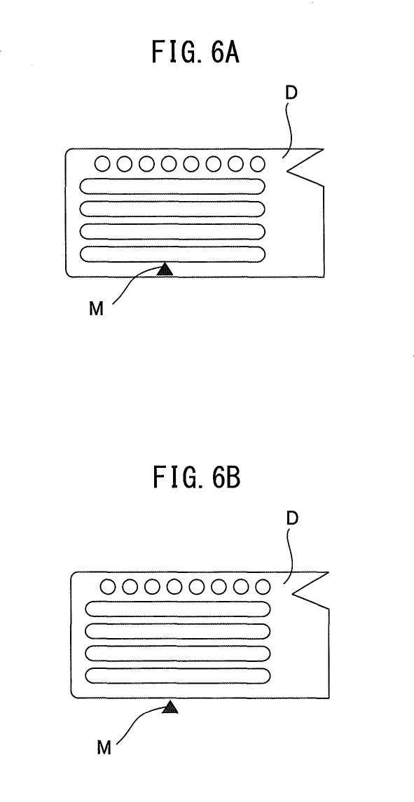

Possible causes of the interruption signal include, for example, detection of a processing defect by a non-illustrated sensor, occurrence of power failure, a drop of supply pressure of the laser gas, and an emergency stop by the operator. Accordingly, the shape or color of the index M provided by the marker 14 may be changed depending on the cause of the interruption signal. For example, FIG. 2 illustrates a circular index M, and FIG. 6A to be subsequently described illustrates a triangular index M. Likewise, when a plurality of indices M are provided on a single piece of workpiece W, the shape or color of the index M may be changed depending on the number of times that the interruption signal has been outputted.

Alternatively, the index M may be provided in the form of character information. In this case, for example the cause of the interruption signal may be indicated as it is in letters, as the index M. The time of day that the interruption signal has been outputted may be indicated as the index M. Providing the index M formed as above facilitates estimation of the causal relationship between the cause of the interruption signal and the processing result of the workpiece W.

FIG. 6A is a plan view of an example of the product. In FIG. 6A, the index M is provided on the product D. In this case, the operator can identify the interruption point even when viewing the product D alone. Such an arrangement is especially advantageous when the micro joint is not formed between the workpiece W and the product D.

FIG. 6B is a plan view of an example of the product in the workpiece. Although not illustrated, it will be assumed that the product D and the workpiece W are connected via the micro joint. In FIG. 6B, the index M is provided on the residual portion R of the workpiece W, adjacent to the product D. In this case, the processing interruption/resumption point can be identified without the index M being left on the product D.

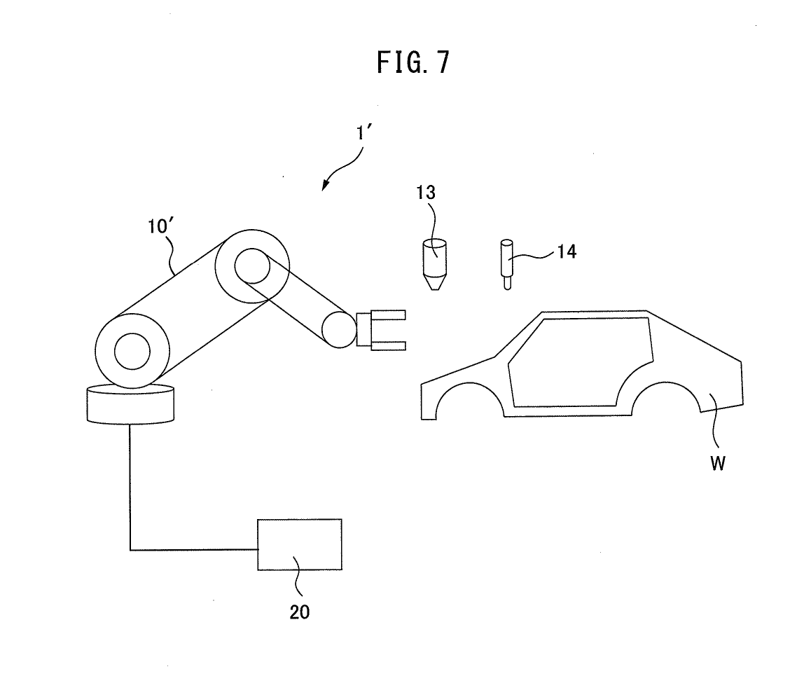

FIG. 7 is a schematic drawing of a laser processing system according to another embodiment of the present invention. In the laser processing system 1′ illustrated in FIG. 7, a multi-articular robot 10′ is provided in place of the laser processing machine 10, and the control unit 20 controls the multi-articular robot 10′. The workpiece W illustrated in FIG. 7 is a body of an automobile. Thus, the workpiece W is not limited to a plate-shaped object.

In the embodiment illustrated in FIG. 7, a hand of the robot 10′ holds the laser processing head 13 and sequentially moves the laser processing head 13 to desired positions, so as to perform the operation specified in FIG. 3. When the laser processing is finished at step S20, the hand of the robot 10′ releases the laser processing head 13 and holds the marker 14. Then at step S21, the robot 10′ moves the marker 14 to the interruption point of the workpiece W and forms the index M on the workpiece W. Accordingly, it is apparent that with the robot 10′ also, the same advantages as those provided by the foregoing embodiment can be attained.

In a non-illustrated embodiment, only the positioning rail 12b may be excluded, and the laser processing head 13 and the marker 14 may be positioned together or independently, along the positioning rail 12a. Such a configuration is also included in the scope of the present invention.

### Effect of the Invention

With the first aspect of the present invention, the operator can recognize that the workpiece includes the interruption point simply by viewing the workpiece, and to easily identify the position of the interruption point. Accordingly, the operator can secure the opportunity to remove or amend the low-quality product as the case may be, and prevent the low-quality product from being delivered to the subsequent process. Therefore, degradation in quality of the product can be prevented.

With the second aspect, the highly visible index is employed and therefore the operator can easily recognize the position of the interruption point.

The third aspect eliminates the need to additionally prepare an engraving apparatus, a printing apparatus, or a paint application unit, thereby allowing the laser processing system according to the first aspect to be manufactured through simplified steps and at a lower cost.

With the fourth aspect, the index is formed on the workpiece with the visible light emitting unit, for example a laser pointer, the advantages of the first aspect can be attained without an engraved mark or a paint being left on the workpiece and the product.

The fifth aspect enables the operator to easily identify which of a plurality of workpieces has the interruption point, and at which point of a large-sized workpiece the interruption point is located.

With the sixth aspect, providing the index in the form of character information and changing the shape or color of the index increases the visibility of the index, and facilitates estimation of the causal relationship between the cause of the interruption signal and the processing result of the workpiece. The character information may include, for example, the time of day that the interruption signal has been outputted, and a numeral indicating the number of times that the interruption signal has been outputted.

The seventh aspect allows the interruption point to be identified, even if the product is separated from the workpiece.

The eighth aspect allows the interruption point to be identified, without the engraved or painted index being left on the product.

Although the present invention has been described above with reference to typical embodiments, it is obvious to those skilled in the art that various modifications, omissions and additions may be made without departing from the scope and spirit of the present invention.

What is claimed is:

1. A laser processing system that processes a workpiece with a laser, the system comprising:
a processing interruption unit that interrupts laser processing of the workpiece in accordance with an interruption signal;
a processing resumption unit that resumes the laser processing of the workpiece after the interruption signal is cancelled; and
an interruption point visualizer providing unit that provides the workpiece with an interruption point visualizer that allows an interruption point on the workpiece where the laser processing is interrupted by the processing interruption unit to be visually recognized.

2. The laser processing system according to claim 1,
wherein the interruption point visualizer is an index formed by one of engraving, printing, and application of a paint, on the interruption point on the workpiece.

3. The laser processing system according to claim 1,
wherein the interruption point visualizer is an index formed by laser processing on the interruption point on the workpiece.

4. The laser processing system according to claim 1,
wherein the interruption point visualizer is the interruption point to be visually recognized when a visible light emitting unit emits visible light onto the interruption point.

5. The laser processing system according to claim 1, further comprising:
a storage unit that stores information of the workpiece to which the interruption point visualizer is provided and information of a position on the workpiece where the interruption point visualizer is located; and
a display unit that displays the information of the workpiece to which the interruption point visualizer is provided, or both of the information of the workpiece to which the interruption point visualizer is provided and the information of the position on the workpiece where the interruption point visualizer is located.

6. The laser processing system according to claim 1,
wherein an index is provided on the workpiece in a form of character information, or a shape or a color of the index or of visible light emitted to the interruption point is changed depending on a cause of the interruption signal or a number of times that the interruption signal has been generated.

7. The laser processing system according to claim 2 or 3, the system being configured to produce at least one product from the workpiece,
wherein the interruption point visualizer providing unit provides the product in the workpiece with the interruption point visualizer.

8. The laser processing system according to claim 2, the system being configured to produce at least one product from the workpiece,
wherein the interruption point visualizer providing unit provides the interruption point visualizer to a remaining portion of the workpiece, except for the product.
